(19) United States
(12) Patent Application Publication
(10) Pub. No.: US 2019/0203633 A1
(43) Pub. Date: Jul. 4, 2019

(54) SPLIT-CYCLE ENGINE

(71) Applicant: Peter Charles Cheeseman, San Francisco, CA (US)

(72) Inventor: Peter Charles Cheeseman, San Francisco, CA (US)

(21) Appl. No.: 16/226,614

(22) Filed: Dec. 19, 2018

Related U.S. Application Data
(60) Provisional application No. 62/607,883, filed on Dec. 19, 2017.

(51) Int. Cl. F02B 1/06; F02M 33/00; F02B 21/02; F02B 41/02

(52) U.S. Cl. CPC F02B 1/06; F02B 41/02; F02B 21/02; F02M 33/00

(57) ABSTRACT

the present disclosure is related to an engine with entry ignition, comprising a compressor coupled to a pressure reservoir, wherein the pressure reservoir comprises a conduit connected to a mixing chamber wherein the mixing chamber comprises a fuel injector, and wherein the mixing chamber is coupled to a combustion chamber, a valve at the opening of the combustion chamber, wherein the valve is configured to open and close one or more channels between the mixing chamber and the combustion chamber, an exhaust valve at the opening of the combustion chamber. and a valve actuator connected to the exhaust valve.

### FIELD OF USE

The invention described herein is a new, efficient split-cycle internal combustion engine. This new engine uses a new combustion method called Entry Ignition (EI) and operates on the Brayton cycle.

### BACKGROUND

The invention disclosed herein is an internal combustion engine of the split cycle type—i.e. an engine in which compression occurs in a separate chamber from the expander chamber. The split cycle type engine is in contrast to standard engines in which compression and expansion occur in the same chamber. Previous inventors have noted the advantages of split cycle engines over standard engines. One advantage is that in a split cycle engine, the expansion volume can be larger than the compression volume, so that the burned gases can be expanded more fully than in standard engines, thus increasing efficiency. Another advantage is that split cycle engines do not have a problem with residual burned gases left over from the previous expansion stroke mixing with the fresh charge during the intake/compression stroke. The present split-cycle engine invention uses constant pressure combustion, and so its operation is approximated by the Brayton cycle. By operating this engine at the maximum pressure and temperature dictated by the autoignition temperature of the fuel, this new engine can achieve significantly higher efficiency than most other internal combustion engines, and simultaneously have clean exhaust.

Split cycle engines can be subdivided in two types: those with a pressure reservoir between the compressor stage and the expander stage; and those with a minimal volume cross-over passage between the two stages. The present invention has a thermally insulated pressure reservoir between the compressor stage and the expander stage, and so is of the pressure reservoir type. Some of the advantages of using a pressure reservoir are: it allows the compressor stage to operate independently of the burner expander stage; it allows constant pressure combustion, and it smooths out pressure fluctuations.

A major difference between the present invention and related prior art split-cycle engines is the use of a new type of combustion disclosed as Entry Ignition (EI), in contrast to prior art engines that use either spark ignition (SI), compression ignition (CI), or Mesh Combustion (MC). In the present disclosure, EI burns a premixed fuel-air mixture, and so does not create significant levels of particulate emissions. Also, EI can burn a leaner fuel-air mixture than is practical with SI and can burn sufficiently lean that NOx production is kinetically inhibited, giving a cleaner exhaust than either SI or CI. Additionally, in EI the flow of the fuel-air mixture through the holes into the combustion chamber is controlled by a valve, and only occurs in one direction. By controlling the degree of opening of the valve, the flow velocity of the charge through the valve can be chosen so that it always exceeds the local flame velocity, and so prevents flame backpropagation into the mixing chamber.

In some prior art engines, combustion occurs in a prechamber before the expander intake valve. In these prior art engines, the extremely hot combustion gases flow through the expander intake valve into the expander, and so creates extreme thermal stresses for this intake valve. In the engine disclosed herein, combustion occurs in the expander combustion chamber after the expander intake valve, and so the expander intake valve is only exposed to the unburned fuel-air mixture, and thus avoids these extreme thermal stresses. In prior art, combustion also occurs on the expander side of the expander intake valve, and so it also avoids the problems associated with overheating this valve. However, there, fuel injection occurs in the expander combustion chamber, where it has to mix with the compressed air before it can burn. This is essentially the same as CI (Diesel) combustion, and so it has the same pollution problems, such as particulates and NOx production. Also, in the prior art, unburned fuel-air mixture can accumulate in the combustion chamber before igniting, because of ignition delays. The resulting pressure spike caused by the rapid combustion of this accumulated charge may create unstable combustion. The combustion problems associated with the prior art are avoided in the present invention because in the present invention, fuel-air mixture preparation occurs in a prechamber located before the expander intake valve, and so only a well-mixed fuel-air mixture flows into the expander combustion chamber through this intake valve, whereupon it burns on entry (EI).

In summary, because the prior art has problems with either overheating the expander intake valve or with polluting and possibly unstable combustion, the current disclosure described herein overcomes these problems. These problems are avoided in the present invention, which uses a new type of combustion (EI) that is inherently non-polluting and stable. At the same time, the present invention provides an engine that is more efficient and less polluting than comparable existing engines.

### SUMMARY

The following presents a simplified overview of example embodiments in order to provide a basic understanding of some aspects of the invention. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

In accordance with the embodiments disclosed herein, the present disclosure is related to an engine with entry ignition, comprising a compressor coupled to a pressure reservoir, wherein the pressure reservoir comprises a conduit connected to a mixing chamber wherein the mixing chamber comprises a fuel injector, and wherein the mixing chamber is coupled to a combustion chamber, a slider valve at the opening of the combustion chamber, wherein the slider valve is configured to open and close one or more channels between the mixing chamber and the combustion chamber, an exhaust valve at the opening of the combustion chamber, and a valve actuator connected to the exhaust valve.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a cross-sectional view of an entry-ignition combustion engine.

FIG. 2A is a cross-sectional view of an entry-ignition combustion engine during the end of its burn phase.

FIG. 2B is a cross-sectional view of an entry-ignition combustion engine during its expansion stroke.

FIG. 2C is a cross-sectional view of an entry-ignition combustion engine after it passes through the bottom dead center position.

FIG. 2D is a cross-sectional view of an entry-ignition combustion engine near the end of its exhaust stroke.

FIG. 3A is a cross-sectional view of an entry-ignition combustion engine with a two-stage compression and two-stage expansion.

FIG. 3B is a cross-sectional view of an entry-ignition combustion engine with a two-stage compression and two-stage expansion.

FIGS. 4A and 4B are cross-sectional views of an entry-ignition combustion engine using an isothermal compressor.

FIGS. 5A, 5B, 5C, and 5D illustrate a cross-sectional view of a slider valve of an entry-ignition combustion engine.

FIG. 6A is a top view of a slider valve and exhaust valve of an entry-ignition combustion engine with the inlet manifold removed.

FIG. 6B1 is a top view of a slider valve and exhaust valve of an entry-ignition combustion engine with the inlet manifold removed.

FIG. 6B2 is a cross-sectional view of a slider valve and exhaust valve of an entry-ignition combustion engine with the inlet manifold removed.

FIG. 6C is a cross-sectional view of a valve layout of an entry-ignition combustion engine.

FIGS. 6D1 and 6D2 are cross-sectional views of a valve layout of an entry-ignition combustion engine.

FIG. 7 is a geometric method for reducing the need to control the intake valve opening rate.

FIGS. 8A, 8B, 8C, and 8D are geometric methods for reducing the need to control the intake valve opening rate.

### DETAILED DESCRIPTION OF THE ILLUSTRATIVE EMBODIMENTS

Before the present methods and systems are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

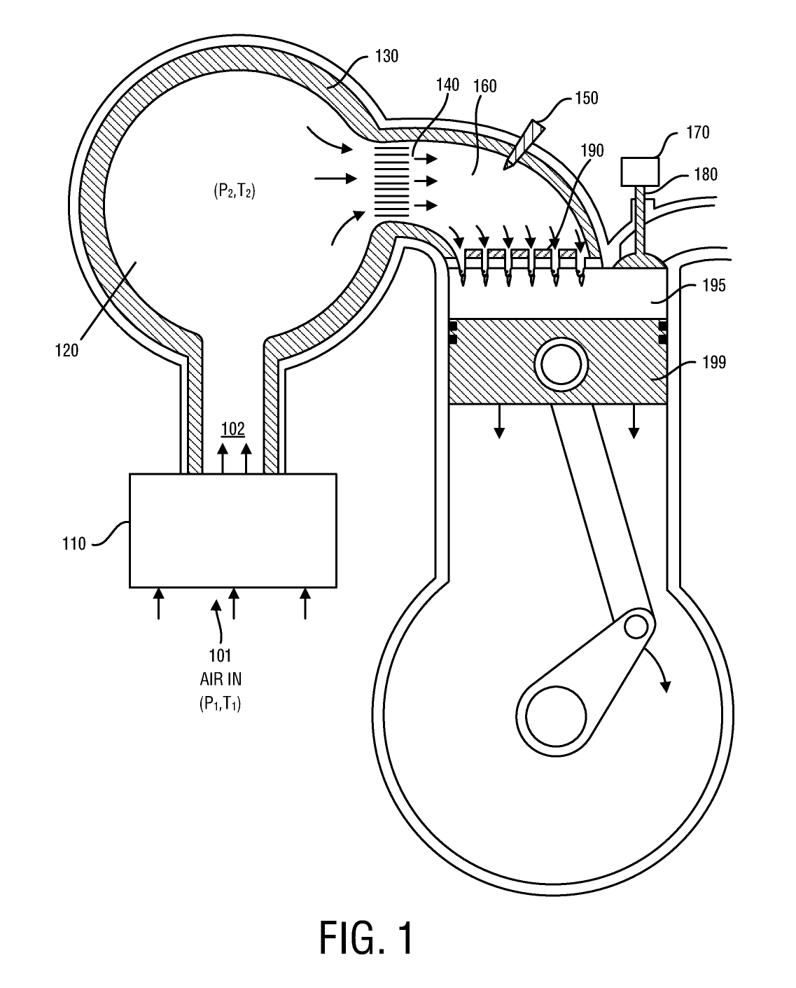

FIG. 1 is a cross-sectional view of an entry ignition engine. As shown in FIG. 1, the entry ignition engine (EI engine) may comprise a compressor 110, a pressure reservoir 120, a thermal insulation layer 130, baffles 140, fuel injector 150, a mixing chamber 160, valve actuator 170, exhaust valve 180, a slider valve 190, and a combustion chamber 195.

In one embodiment, the compressor 110 may take in 101 air at pressure P1 and temperature T1, and output 102 air at pressure P2 and temperature T2. This compressed air flows into the pressure reservoir 120 which is preferably lined with a thermal insulation layer 130. The embodiment in FIG. 1 is shown toward the end of its burn phase, where a premixed fuel-air mixture in the mixing chamber 160 is flowing through the holes in the top of the combustion chamber 195. This flow is possible because at this stage, the slider valve 190 is in a position that lines up with the holes in the cylinder head of the combustion chamber 195, allowing gas to flow between the mixing chamber 160 and the combustion chamber 195. As this premixed charge jets into the combustion chamber 195, it turbulently mixes with the very hot burned gases already in the combustion chamber 195, causing this inflowing mixture to burn and expand into the combustion chamber 195.

The EI engine provides the benefits of allowing a leaner burn than is possible for SI combustion because EI does not depend on flame propagation speed, as is the case for SI combustion. As a result, the EI engine may burn sufficiently lean such that nitrous oxide (NOx) production is kinetically inhibited and NOx cleanup in the exhaust system is not needed. Because the EI engine may burn a well-mixed fuel-air mixture, it may not produce significant particulate pollution. Additionally, only burned gases may be released from crevices during the expansion stroke, such that they do not contribute to pollution or reduced combustion efficiency.

During the combustion phase shown in FIG. 1, the exhaust valve 180 is closed, so that the hot, high pressure burned gases act on the piston 199 to push it down and do work on the crank—i.e. a power stroke. The exhaust valve 180 is opened and closed by the valve actuator 170. The valve actuator 170 may be any of the commonly used valve actuator mechanisms, such as cams or electromechanical actuators. The exhaust valve 180 may open and close at a fixed crank angle, such that variable valve timing is not needed.

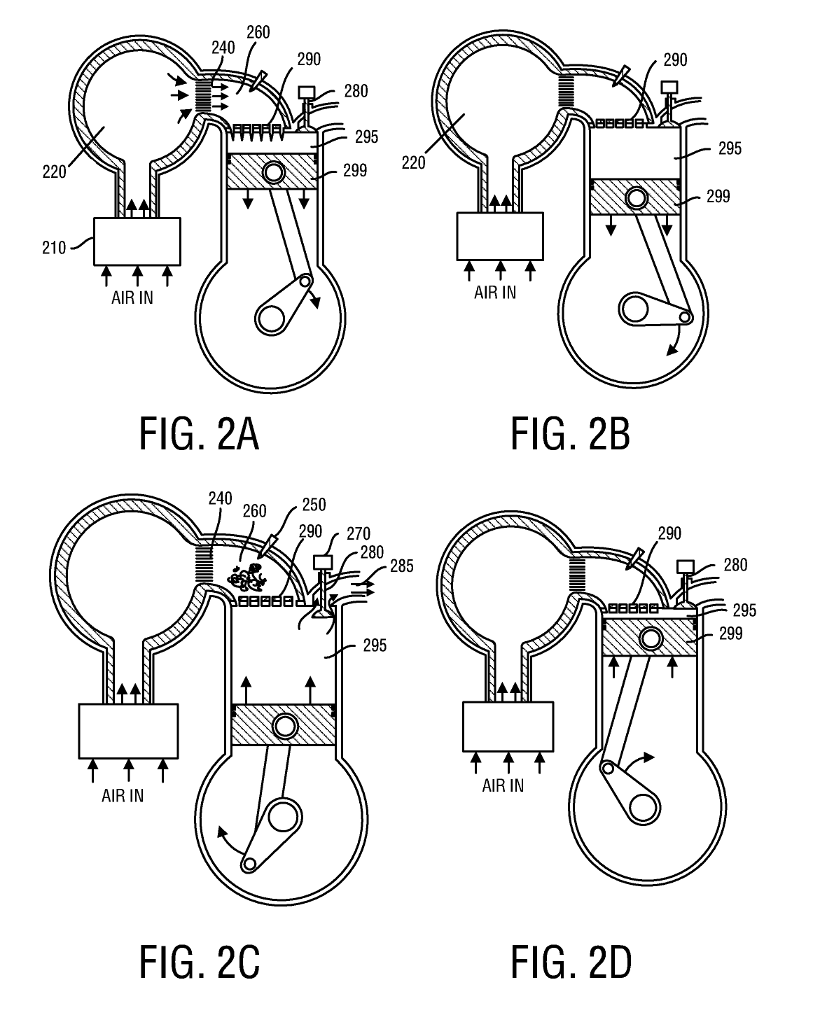

FIG. 2A is a cross-sectional view of an entry-ignition combustion engine during the end of its burn phase. In one embodiment, as shown in FIG. 2A, the slider valve 290 may be open, allowing the premixed charge in the mixing chamber 260 to flow into the combustion chamber 295, with the premixed charge burning as it enters the combustion chamber 295. At the same time, air may flow from the pressure reservoir 220 through the baffles 240 and into the mixing chamber 260 to replace the charge that is flowing into the combustion chamber 295. During the burn phase, there may be an open passage from the pressure reservoir 220 to the combustion chamber 295. This may allow combustion to occur at a near-constant pressure. This near constant pressure can occur because the volume of the pressure reservoir 220 is much larger than the volume of air consumed in a single burn. The compressor 210 may supply fresh compressed air to the pressure reservoir 220 to make up for that lost during the burn phase—the result being that the pressure reservoir 220 stays at an almost constant pressure. In effect, the pressure reservoir 220 may act as a buffer between the compressor 210 and the expander piston 299, smoothing out the pressure fluctuations caused by the entry and exit of packets of air into and out of the pressure reservoir 220. In one embodiment, for situations where the pressure exceeds the pressure reservoir's 220 maximum design pressure, the pressure reservoir 220 may optionally be fitted with a pressure relief valve. Such a pressure relief valve may not be necessary but can be added for extra safety.

FIG. 2B is a cross-sectional view of an entry-ignition combustion engine during its expansion stroke. In an embodiment of the EI engine during its expansion stroke, the slider valve 290 may be closed, isolating the mixing chamber 260 from the combustion chamber 295. During the expansion stroke and the subsequent exhaust stroke, the pressure in the combustion chamber 295 may be less than that in the mixing chamber 260, such that the slider valve 290 is firmly pressed against the supporting cylinder head of the combustion chamber 295 and against the edges of the openings it is covering up. This pressure difference helps seal the slider valve 290 in its closed position. In this embodiment, the volume of the mixture in the mixing chamber 260 may be greater than the volume of the premixed charge that flows into the combustion chamber 295. This is to ensure that the charge flowing into the combustion chamber 295 is not diluted by the air flowing through the baffles 240 into the mixing chamber 260. This larger volume may ensure that there is residual fuel-air mixture present in the mixing chamber 260 when the slider valve 290 closes. This residual charge may become rapidly diluted by the air flowing in from the pressure reservoir 220. This dilution may reduce the likelihood of premature combustion in the mixing chamber 260.

FIG. 2C is a cross-sectional view of an entry-ignition combustion engine after it passes through the bottom dead center position. As shown in FIG. 2, as the piston approaches a bottom dead center position (BCD), the exhaust valve 280 may open, driven by the valve actuator 270, thus initiating flow of the burned gases out through an exhaust port 285. These exhaust gases can either be exhausted to the atmosphere through a standard type of exhaust system, or undergo further expansion in a second stage expander, and then exhausted through the exhaust system. During this exhaust stroke, the fuel injector 250 may spray fuel into the mixing chamber 260. The fuel may be injected at sufficient pressure that the turbulence created by the fuel flow causes the fuel to vaporize and mix with the hot, compressed air already in the mixing chamber 260. During this turbulent mixing process, the baffles 240 may prevent the turbulence from backpropagating into the pressure reservoir 220, confining the fuel-air mixture to the mixing chamber 260. The baffles 240 may comprise an array of parallel channels open at each end, and of small enough width that large scale vortices may not fit through them. Fuel injection may begin any time after the slider valve 290 closes and should stop before the slider valve 290 reopens, allowing sufficient time for the fuel and air to become well mixed before the slider valve 290 reopens.

FIG. 2D is a cross-sectional view of an entry-ignition combustion engine near the end of its exhaust stroke. As shown in FIG. 2D, as the piston approaches a top dead center (TDC) position, the exhaust valve 280 may close, thus trapping a small amount of residual burned gases in the combustion chamber 295. The piston 299 may continue to rise so that at TDC there is only a very small clearance between the top of the piston 299 and the cylinder head of the combustion chamber 295. After the exhaust valve 280 closes, the piston motion may recompress the burned gases to a pressure well above the exhaust pressure, but less than P2—the pressure in the mixing chamber 260. Around TDC, or very shortly after, the slider valve 290 may start opening, allowing the premixed charge in the mixing chamber 260 to jet into the combustion chamber 295. This jetting behavior mixes the inflowing charge with the hot recompressed exhaust gases, causing the charge to burn, and thus initiating a new burn phase. For this mixing burn to happen, the temperature of the recompressed exhaust gases may be well about the charge ignition temperature. Continuation of this burn, as the piston 299 descends, may return the engine to the situation shown in FIG. 2A, thus completing the cycle.

FIGS. 1, 2A-2D thus disclose embodiments of a split cycle engine—i.e., an engine with separated compression and expansion stages. The embodiments shown in FIGS. 2A-2D disclose a 2-stroke cycle for the burner/expander, with FIGS. 2A, 2B comprising the burn/expansion stroke, and FIGS. 2C, 2D comprising the exhaust/recompression stroke. It will also be appreciated that for maximum thermal efficiency, P2 should be as high as practically possible. T2 should also be as high as possible, but below the autoignition temperature of the fuel air mixture, to prevent premature combustion (i.e. combustion in the mixing chamber 260). Note that if premature combustion should occur in the mixing chamber 260 it would not damage the engine, because the mixing chamber 260 is directly connected to the pressure reservoir 220, and so the resulting combustion pressure rise would be largely absorbed by the pressure reservoir 220. It will also be appreciated by those skilled in the art that an engine according to the present invention may operate on the Brayton, cycle, and not the more common Otto or Diesel cycles. That is, the compressor 210 (approximately) adiabatically compresses air, which is then further heated by burning fuel in it at constant pressure, and these very hot gases are then (approximately) adiabatically expanded back to atmospheric pressure.

In FIGS. 1 and 2A-2B, the compressor stage of the engine is shown as a schematic box that takes in air at pressure P1 and temperature T1 (typically ambient pressure and temperature), and adiabatically compresses it to pressure P2 and temperature T2, which is then delivered to the pressure reservoir 220. Any type of compressor may perform this function, including, but not limited to piston, scroll, screw or centrifugal compressors. To maximize the efficiency of the present disclosure, it may be desirable to compress the air to a very high pressure and temperature. Many of the known types of compressors have difficulty achieving this high pressure in a single stage or do so inefficiently. A standard solution to the problem of achieving high pressure compression is to use staged compression—i.e. the output of one compressor is fed as input to the next stage. There is no requirement that these stages be of the same type. For example, in supercharged engines, a centrifugal compressor feeds compressed air into a piston compressor to achieve a high combined pressure ratio (2-stage compression). In staged compression, there may or may not be a pressure reservoir between stages to buffer the air flow between stages. Just as the compressor of the present invention can be multi-staged, the expander as shown in FIG. 1 can also be multi-staged. Note that in the present disclosure, it is the pressure reservoir 220 that may decouple the compression stage from the burn/expansion stage, allowing any type of compressor to be used. The temperature of the compressed air in pressure reservoir 220 (T2) may be required to be sufficiently below the autoignition temperature of the fuel-air mixture that combustion does not occur prematurely in the mixing chamber 260.

In another embodiment, the power required to drive the compression stage may be supplied externally or come from the output shaft of the expander stage, or some combination of external and internal sources. In an embodiment where an expander output shaft is used as the power source for the compressor 210, the compressor 210 can be directly joined to the expander output shaft (i.e. the compressor and expander are on a common shaft). Alternatively, the compressor 210 and expander shafts can be joined via a gear box, or a continuously variable transmission. Such an arrangement allows the compressor 210 to be driven at a different speed than the expander, giving a method of controlling the air flow rate into the pressure reservoir 220.

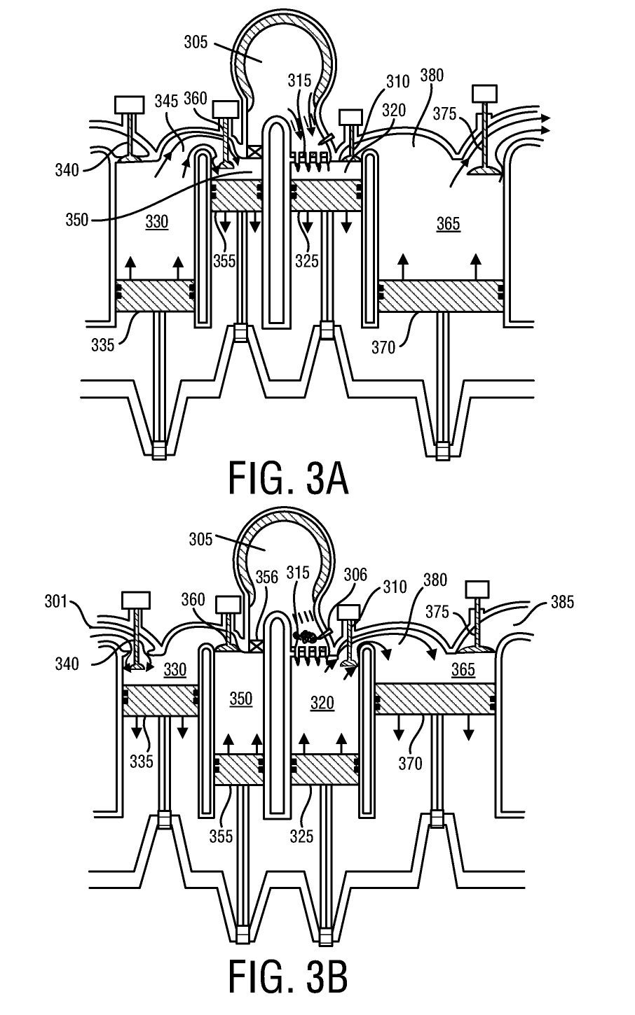

FIG. 3A is a cross-sectional view of an entry-ignition combustion engine with a two-stage compression and two-stage expansion. As shown in FIG. 3A, the compressor and expander stages may be linked together on a common shaft. FIG. 3A discloses an embodiment where a first stage compressor piston 335 is moving upward, while the second stage compressor piston 355 is moving downward. The intake valve 340 may be closed, while valve 360 is open and so air is flowing through the crossover passage 345 from the first compression chamber 330 to a second compression chamber 350. Because the second compression chamber 350 has substantially less volume than the first compression chamber 330, the air being transferred from the first compression chamber 330 to the second compression chamber 350 is being compressed in the process (first stage compression). Simultaneously, a piston 325 may move downward, and a fresh charge is flowing into combustion chamber 320 through the slider valve 315, burning as it enters, as previously described. The very high pressure in the pressure reservoir 305 and the expansion of the burned gases in the combustion chamber 320 discloses an embodiment of a power/expansion stroke. As this power stroke occurs, an exhaust valve 310 may be closed, isolating the combustion chamber 320 from an exhaust chamber 365. At the same time, a second exhaust valve 375 may be open, such that as the second piston 370 moves upward, it pushes the exhaust gases out through the exhaust manifold (exhaust stroke).

FIG. 3B is a cross-sectional view of an entry-ignition combustion engine with a two-stage compression and two-stage expansion. FIG. 3B discloses an engine state shifted 180 degrees in crank angle relative to FIG. 3A. As shown in FIG. 3B, the first stage compressor piston 335 may move downward, while the inlet valve 340 is open, such that fresh air is being drawn into the compression chamber 330 (intake stroke). The valve 360 may be closed so that the first compression chamber 330 is isolated from the second compression chamber 350. Simultaneously, the second stage compressor piston 355 is moving upward compressing the air trapped in the second compression chamber 350 (2^{nd} stage compression). This compression may proceed until the pressure in the second compression chamber 350 exceeds that in the pressure reservoir 305, whereupon the check valve 356 opens, allowing the compressed air in the second compression chamber 350 to flow into the pressure reservoir 305. This air transfer may proceed until the second stage compressor piston 355 reaches TDC, whereupon the check valve 356 closes, trapping the compressed air in the pressure reservoir 305. At the same time, the piston 325 is moving upward, while the second piston 370 is moving downward, and the exhaust valve 310 is open. In this situation, the piston 325 is pushing the exhaust gases in the combustion chamber 320 through the exhaust valve 310 and through the crossover passage 380 into the exhaust chamber 365. Because the volume of the exhaust chamber 365 is substantially greater than that of the combustion chamber 320, the exhaust gases are being further expanded in the process of this gas transfer (second stage expansion). While this gas transfer from the combustion chamber 320 to the exhaust chamber 365 is taking place, the fuel injector 306 is injecting fuel into the pressure reservoir 305. During this second stage expansion, the exhaust valve 375 is closed, preventing the exhaust gases from escaping the second chamber 365 for the duration of the expansion.

The operation of the EI engine disclosed in FIGS. 3A-3B may take place in packets of air through the intake manifold and compress them in two stages into the pressure reservoir 305. At the same time, packets of air may flow out of the pressure reservoir 305 into the mixing chamber 320 where fuel is added from the fuel injector 306. Subsequently, packets of this premixed charge may be admitted into the combustion chamber 320 through the slider valve 315, burn on entry, and then undergo first stage expansion in chamber 320. Packets of burned gases undergo second stage expansion in the second chamber 365, and finally leave via the exhaust manifold 385. In summary, there may be a one-way flow of packets of air from the intake manifold 301 to the exhaust manifold 385, with fuel being added and burned along the way. In another embodiment, by suitably weighing the pistons, an engine according to FIGS. 3A and 3B may be balanced like any 4-inline engine.

In one embodiment, in order to maintain constant pressure in the pressure reservoir 305, the mass flow rate of air into the pressure reservoir 305 may equal the flow rate out of the pressure reservoir 305. If the inflow rate exceeds the outflow rate, then the pressure in the pressure reservoir 305 may rise; and if the flow rates are reversed, then the pressure in the pressure reservoir 305 may fall. In another embodiment, keeping the pressure of the pressure reservoir 305 constant may require a pressure sensor attached to the pressure reservoir 305 and means for controlling the air flowing into or out of the pressure reservoir 305 (or both). Controlling air inflow into the EI engine may be achieved by controlling the timing of the intake valve 340 by closing it early or late relative to nominal BDC closing. This is similar to Miller cycle used in prior art engines. Likewise, outflow control from the pressure reservoir 305 may be achieved by varying the timing of the closure of the slider valve 315. The engine controller may use information from the pressure reservoir pressure sensor to choose the intake valve 340 timing and/or the slider valve 315 timing to maintain the pressure in the pressure reservoir 305 at the desired level. In FIGS. 3A and 3B, the inlet valve 340 and the valve 360 are shown as poppet valves, but they may comprise check valves instead, and if so, would not need valve actuators.

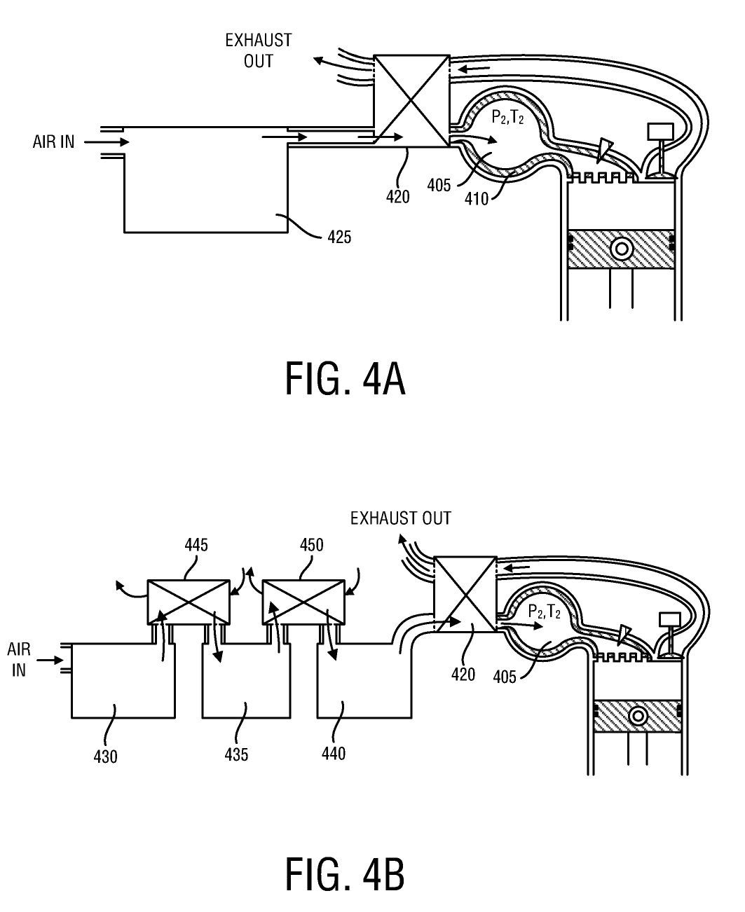

FIGS. 4A and 4B are cross-sectional views of an entry-ignition combustion engine using an isothermal compressor. As shown in FIGS. 4A and 4B, a more thermally efficient alternative to using an adiabatic compressor to provide hot compressed air to a pressure reservoir 405 may comprise using an isothermal compressor, and to heat the cold compressed air using hot exhaust gases. In FIG. 4A, air may be isothermally compressed by a compressor 425 and the resulting cold compressed air then flows into a heat exchanger 420. As this cold compressed air passes through the heat exchanger 420, it may be heated by the exhaust gases, which are cooled in the process. After passing through the heat exchanger 420, the hot compressed air flows into the pressure reservoir 405 while the cooled exhaust gases are exhausted to the atmosphere. The result is that hot compressed air at pressure P2 and temperature 12 is delivered to the pressure reservoir 405. A particular embodiment of the process shown in FIG. 4A is shown in FIG. 4B.

In the FIG. 4B embodiment, air may be compressed in three stages by compressors 430, 435, 440, and the compressed air of each stage is cooled back to ambient temperature by intercoolers, 445, 450, inserted between the compressor stages. A cooling fluid, such as air, may flow through these intercoolers, carrying away the compression heat of each compressor stage, except for the last compressor stage. This process of staged compression with intercooling between stages approximates isothermal compression. Clearly, more stages may give a better approximation to isothermal compression, but at additional cost and increased losses, such as friction. Other embodiments may comprise additional methods for achieving near isothermal compression of air and may be used instead of that shown in FIG. 4B. Using isothermal compression and heating the compressed air using the exhaust heat may boost efficiency by using exhaust heat that would be otherwise wasted.

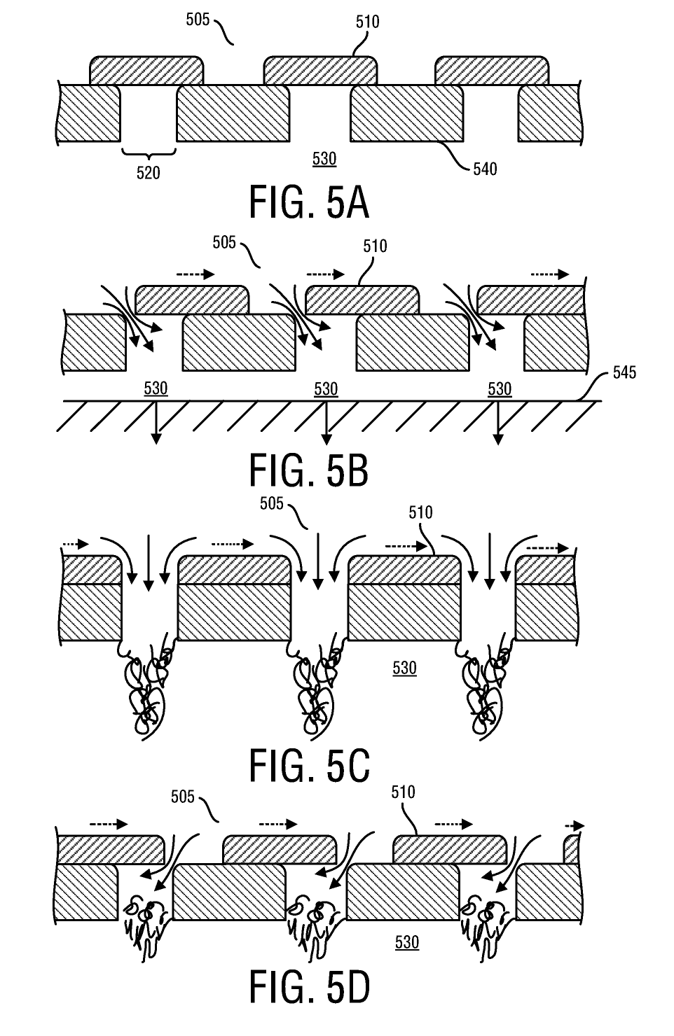

FIGS. 5A, 5B, 5C, and 5D illustrate a cross-sectional view of a slider valve of an entry-ignition combustion engine. FIG. 5A discloses a slider valve 510 in its resting position. It may remain in this position from shortly after the end of a burn phase until near the end of an exhaust stroke—i.e. for most of the engine cycle. As the piston approaches TDC, the slider 510 may begin to move to the right; and very shortly after TDC, it may be in a position shown in FIG. 5B, still moving to the right. In the FIG. 5B position, a small gap between the slider and the head slots 520, has opened up, allowing the premixed fuel-air mixture to flow into the combustion chamber 530 from the mixing chamber 505 above. In the FIG. 5B configuration, the re-pressurized exhaust gases in the combustion chamber are at a lower pressure than the gases in the mixing chamber above, so that the fuel-air mixture jets into the combustion chamber and turbulently mixes with the gases in the combustion chamber 530 below. This mixing may cause the in-flowing fuel-air mixture to heat up and burn.

Embodiments of the EI engine are fundamentally different from spark ignition (SI), because in EI there is no freely propagating flame front. EI can burn leaner than SI because EI is not limited by the flame propagation speed. EI can burn lean enough that production of NOx pollutants is kinetically suppressed, so NOx cleanup in the exhaust is not needed. EI is also different from compression ignition (CI) because in EI it is a premixed fuel-air mixture that flows into the combustion chamber and burns on entry. CI on the other hand injects fuel into the combustion chamber which has to subsequently vaporize, mix and burn. This diffusion limited CI combustion creates NOx and particulates. EI and SI do not produce significant particulates, because both EI and SI burn a premixed charge. Another important feature of EI is that it can burn any fuel, liquid or gaseous, provided only that the fuel injector is capable of injecting the fuel. Since fuels vary in their autoignition temperature, fuels with higher autoignition temperature, such as natural gas and gasoline, allow the engine to operate at higher temperature T2 (with corresponding higher pressure P2), and so give the engine higher efficiency.

FIG. 5C shows the slider valve 510 at approximately mid-burn position when the slider valve 510 has exposed the maximum intake area of the entry slot 520. At this point, the continued downward motion of the piston may draw fresh charge into the combustion chamber, creating a flame at the exit of each entry slot 520, which causes the inflowing charge to burn. As the slider valve 510 continues to move to the right, the situation shown in FIG. 5D is reached, where the inflowing charge is about to be cut off. Continued motion of the slider valve 510 returns it to the situation shown in FIG. 5A, ready for the next cycle. In the next cycle, the slider valve moves to the left instead, so that over the course of two cycles, the slider valve 510 is back to where it started. In its closed position, the slider valve 510 is firmly pressed against the head 540 because the pressure in the combustion chamber 530 is less than that in the mixing chamber 505. This pressure difference helps seal the slider valve 510, preventing leakage between the two chambers through the valve contact area.

In additional embodiments, whatever valving type is used for controlling the charge intake, it may be required to be fast, especially at maximum engine speed, because it has to open and close over a relatively small crank angle (typically 20 to 40 degrees). The slider type valve shown in FIGS. 5A-5D have speed advantages over other valve types, such as poppet valves. In particular, a poppet has to accelerate and decelerate twice in order to go from a closed position to an open position and back again, whereas the slider valves shown in FIGS. 5A-5D only accelerate and decelerate once, and so operate in half the time of a poppet valve moving over the same distance. Also, the slider valve shown in FIG. 5A may start accelerating before TDC, and so when the slider valve 510 reaches the position shown in FIG. 5B, it is already moving at a considerable velocity, leading to a fast opening. Likewise, in the position shown in FIG. 5C, the slider is decelerating but still moving fast, producing a fast shutoff, while continuing to decelerate after closure. Overall, the slider valve may operate over a larger crank angle than poppet valve because of this early acceleration start and late deceleration finish. This larger operating crank angle means that the necessary acceleration and deceleration magnitudes are reduced relative to a poppet type valve.

In other embodiments, any of the known engine valve actuators can be adapted for used in the present disclosure, such as cam, hydraulic or electromagnetic actuators. In particular, the poppet valves can use a simple mechanical cam actuator synced to the crankshaft, because their timing occurs at a fixed crank angle. In contrast, the slider valve 510 preferably has a variable closing angle chosen cycle by cycle by the engine controller. The closing angle determines how much fuel-air mixture is admitted into the combustion chamber 530 and this angle is chosen to keep the pressure in the pressure reservoir at a chosen constant value, and to control the power output of the engine. This variable valve closing angle requires a more complex actuator than for the other valves.

In one embodiment, a requirement on the slider valve 510 may be the charge flow velocity at the valve throat exceeding the local flame propagation speed, over all engine operating speeds. Otherwise, a flame could backpropagate through the valve opening and initialize burning in the mixing chamber 505. Such premature combustion could cause the engine head to overheat, and so should be avoided. If, however, premature combustion does occasionally occur it will not create a significant pressure spike, because the mixing chamber 505 is directly connected to the much larger pressure reservoir, which will essentially absorb the pressure increase. Also, the thermal inertia of the slider valve 510 may prevent overheating from such occasional premature combustion.

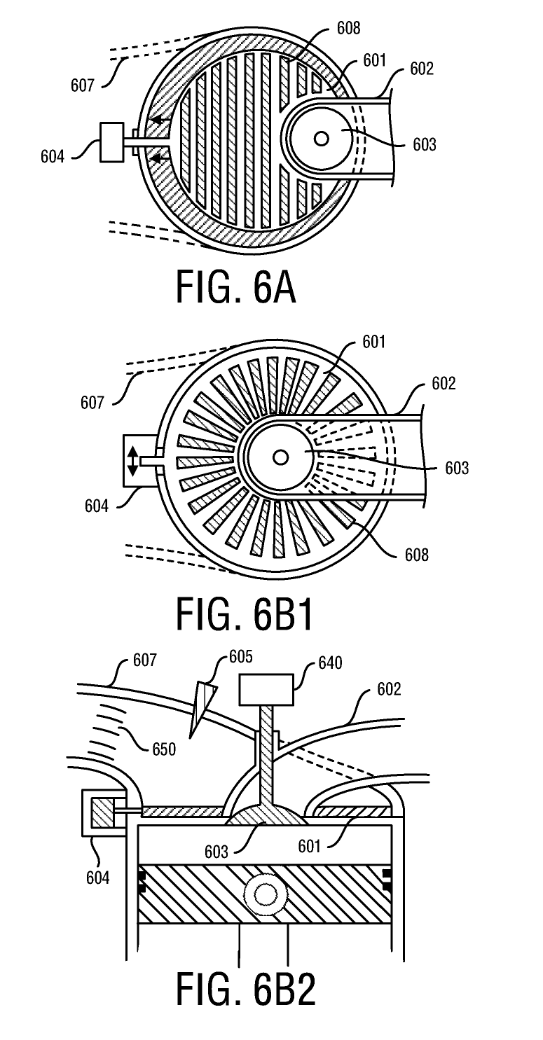

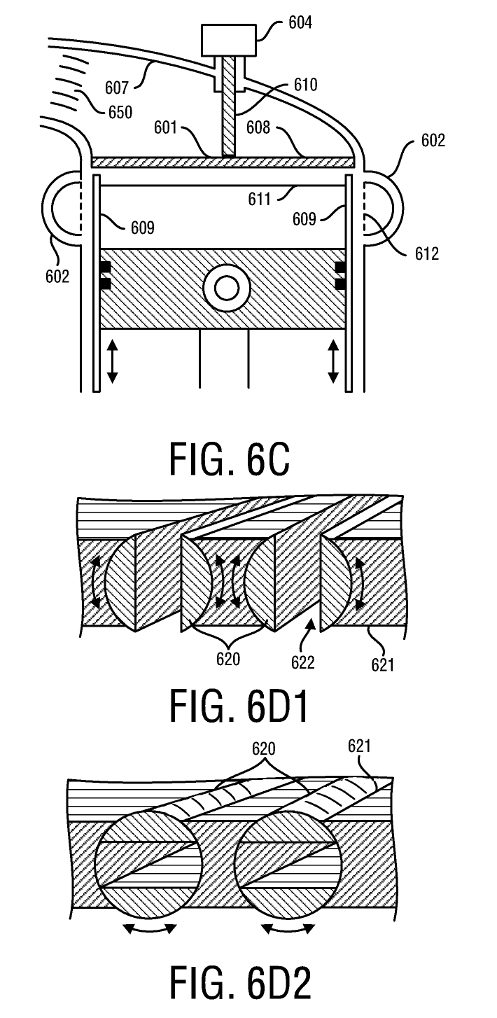

FIG. 6A is a top view of a slider valve and exhaust valve of an entry-ignition combustion engine with the inlet manifold removed. FIG. 6A discloses a linear inlet slider valve 601 in an extreme right closed position. In the next cycle, the linear inlet slider valve 601 is shifted to the left closed position. These alternating shifts may be driven by an actuator 604. When the linear inlet slider valve 601 is moving between these two extreme positions, the slots 608 in the linear inlet slider valve 601 may line up with corresponding slots in the cylinder head, and so allow the charge in the mixing chamber to flow into the combustion chamber below. The exhaust poppet valve 603 may be separated from the linear inlet slider valve 601 by the exhaust manifold 602 and operate independently of the linear inlet slider valve 601.

FIG. 6B1 is a top view of a slider valve and exhaust valve of an entry-ignition combustion engine with the inlet manifold removed. FIG. 6B2 is a cross-sectional view of a slider valve and exhaust valve of an entry-ignition combustion engine with the inlet manifold removed. As shown in FIGS. 6B1 and 6B2, the exhaust poppet valve 603 is located in the center, surrounded by the exhaust manifold 602 and driven by an actuator 640. The inlet valve is in the form of an annular slider valve 601 with radial slots 608 cut into it. The radial slots 608 line up with corresponding radial slots in the cylinder head while the slider is rotating from one stationary position to the next. That is, when the rotary slider is stationary, it may cover up the head slots, and expose them when it rotates through an angle given by the slot separation. The direction of motion of the annular slider valve 601 can alternate between cycles, so that over the course of two cycles, the slider is back to its original position, similar to the motion of the liner slider shown in FIG. 6A. Alternatively, the annular slider valve 601 can continue to rotate in the same direction in successive cycles. In either case, the annular slider valve 601 is driven by the actuator 604.

FIG. 6C is a cross-sectional view of a valve layout of an entry-ignition combustion engine. As shown in FIG. 6C, the exhaust poppet valve on the cylinder head is replaced by a sleeve valve 609 that alternately covers up and exposes exhaust port 612. This sleeve valve can be actuated from below, as is usually the case for sleeve valves. The exhaust gases may be conducted away by the exhaust manifold 602. The inlet valve is a disc with radial slots 608 cut into it, with corresponding slots 611 in the cylinder head, similar to that shown in FIG. 6B. In FIG. 6C, the rotary disc slider valve 601 is driven by the centrally located rotary actuator 604 through shaft 610. The inlet valves shown in FIGS. 6A, 6B and 6C comprise slider types (linear or rotary).

FIGS. 6D1 and 6D2 are cross-sectional view of a valve layout of an entry-ignition combustion engine. One embodiment of a rotary inlet valve is disclosed in FIGS. 6D1 and 6D2. FIG. 6D1 shows the rotary valves 620 in their open position, while FIG. 6D2 shows them in their closed position. In the open position, the charge in the mixing chamber above flows through the slots 622 in each cylindrical rotary valve 620 into the combustion chamber below. The rotary valves 620 may be ganged together so that they can all be driven by a single rotary actuator. This rotary actuator can reverse the direction of rotation between rest positions or can continue to rotate in the same direction.

All of the inlet valve types disclosed may be controlled by the valve actuator so that the exposed flow area has the desired value. Controlling the inflow area is important, because this dictates the gas flow rate into the combustion chamber, and if the gas flow rate is too low, the flame could backpropagate into the mixing chamber, leading to the valve overheating. This backpropagation is particularly likely shortly after the pressures in the mixing and combustion chambers have equilibrated, but the piston is still moving slowly. Conversely, if the flow area is too low, this leads to excessive pressure drop through the valve, leading to reduced efficiency.

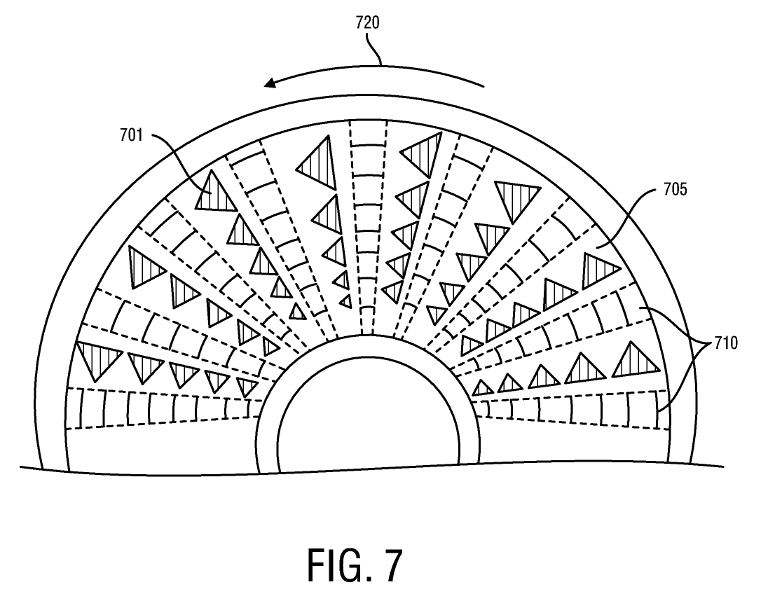

FIG. 7 is a geometric method for reducing the need to control the intake valve opening rate. As shown in FIG. 7, half of a rotary valve 705 similar to that in FIGS. 6B1, 6B2, and 6C is shown. The primary difference between the rotary valve 705 in FIG. 7 and that in the previous figures is that in FIG. 7, the intake slots are replaced by a sequence of triangular holes 701 forming a “saw-tooth” pattern. The rotary valve 705 shown in FIG. 7 is in its closed position, where the triangular holes do not overlap the slots in the cylinder head 710. In this closed position, the rotary valve 705 is covering the head slots 710 so no gas can flow between the mixing chamber and the combustion chamber. When operated, the rotary valve 705 may rotate counter-clockwise 720, and as it does so, the triangular holes 701 line up with the head slots 710 allowing the charge in the mixing chamber to flow into the combustion chamber.

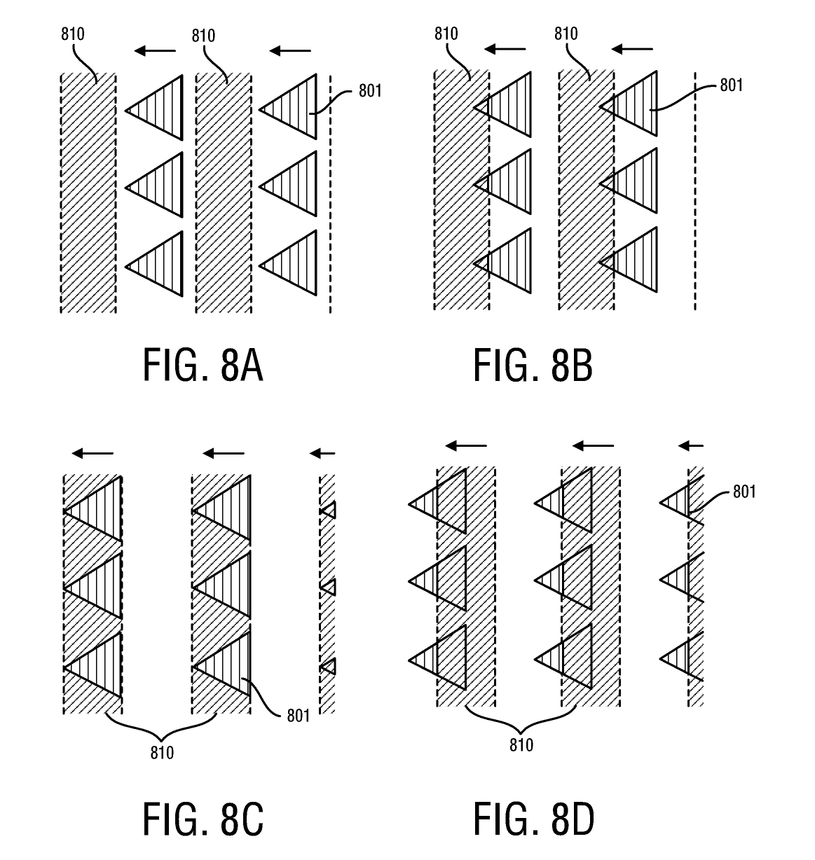

FIGS. 8A, 8B, 8C, and 8D are geometric methods for reducing the need to control the intake valve opening rate, such as shown in FIG. 7. FIGS. 8A-8D disclose inflow area at a sequence of points during an opening process. In FIG. 8A, the rotary valve is in its closed position, corresponding to that in FIG. 7, so here the gas inflow area is zero. In one embodiment, the rotary valve moves to the left and the configuration shown in FIG. 8B is reached, where the tip of the triangular holes 801 overlaps the head slots 810. At this point, gas begins jetting through the small holes into the combustion chamber. As a rotary valve continues to move to the left, the triangular flow area increases quadratically with rotation angle, until the configuration shown in FIG. 8C is reached. This is the point of maximum flow area. The rotary valve continues to move to the left, so that the flow area forms a quadrilateral shape as shown in FIG. 8D. As the rotary valve continues to rotate, the flow area continues to decrease, until it reaches its rest position, as shown in FIG. 7 and FIG. 8A. Before reaching the rest position, the flow area drops to zero, thus shutting off the gas flow. The gas flow shutoff rate is more abrupt in the version shown in FIG. 7 and FIGS. 8A-8D, then that shown in FIGS. 6B and 6C. Non-exposed flow area (lightly shaded) in FIG. 8D, is only growing quadratically, rather than linearly. This relatively faster shutoff reduces the pressure drop of the gas flow through the holes, and so increases efficiency.

As explained above, in a preferred embodiment, an engine according to the present disclosure uses Entry Ignition (EI) to ignite and burn the premixed charge entering into the combustion chamber through the inlet valves. At the beginning of the charge inflow, the recompressed exhaust gases left over from the previous cycle are much hotter than the unburned charge entering the combustion chamber. When this initial charge flow mixes with these prior exhaust gases, the resulting increase of charge temperature causes it to burn. As the charge continues to flow into the combustion chamber, it mixes with the already burned gases, ensuring its continued combustion. This combustion continues until the inlet valve shuts of the flow of fresh charge. However, during a cold start, there are no hot exhaust gases already in the combustion chamber to initiate EI, so a means to initiate combustion during a cold start is necessary. One means is to include a spark plug, or similar ignition means, in the mixing chamber that is only activated during the startup cycle. The spark plug fires after fuel injection, when the fuel and air are well mixed, and this causes the charge in the mixing chamber to burn, so very hot gases will enter into the combustion chamber. On the next cycle, and all subsequent cycles, the residual hot exhaust gases will ensure normal EI. Once EI is initiated, no further spark plug firings should occur, so there is no further combustion in the mixing chamber. While combustion in the mixing chamber is generally to be avoided because it can overheat the inlet valves, a single combustion event during startup will not cause a problem because of the thermal inertia of the inlet valves. Alternatively, for cold start ignition, the ignition means can be located on the underside of the inlet valves, rather than in the mixing chamber. Such ignition means include the usual suspects, such as spark plug(s), hot wire(s), glow-plug, etc. A simpler, passive alternative ignition means is to place one or more catalytic wires at the exit of the inlet valves.

As will be appreciated by anyone skilled in the art, an engine according to the present invention is similar in many respects to existing internal combustion engines, and so can advantageously use the technology developed for them. In particular, standard methods for lubrication, cooling, fuel injection, speed control, etc., can be adapted to the engine described here. In addition, the engine according to the present invention can be boosted, super-charged or throttled. These methods change the pressure, temperature and density of the air entering into the compressor stage, and so allow the power output of the engine to be varied. Note that because the pressure in the pressure reservoir is controlled, increasing the pressure of the inlet air does not increase the pressure in the pressure reservoir.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein.

What is claimed is:

1. An engine with entry ignition, comprising:
a compressor coupled to a pressure reservoir, wherein the pressure reservoir comprises a conduit connected to a mixing chamber;
wherein the mixing chamber comprises a fuel injector, and wherein the mixing chamber is coupled to a combustion chamber;
a valve at the opening of the combustion chamber, wherein the valve is configured to open and close one or more channels between the mixing chamber and the combustion chamber,
an exhaust valve at the opening of the combustion chamber, and
a valve actuator connected to the exhaust valve.

2. The engine of claim 1, wherein the conduit connecting the pressure reservoir to the mixing chamber comprises a baffle.

3. The engine of claim 1, further comprising a thermal insulation layer for at least one of: the pressure reservoir, the conduit connecting the pressure reservoir to the mixing chamber, the mixing chamber, and combinations thereof.

4. The engine of claim 1, wherein the compressor comprises an isothermal compressor and wherein a heat exchanger couples the isothermal compressor to the pressure reservoir.

5. The engine of claim 1, further comprising two or more compressors, wherein one or more intercoolers connects the two or more compressors to each other.

6. The engine of claim 1, wherein the mixing chamber further comprises means for a cold start ignition.

7. The engine of claim 1, further comprising at least one of: a linear inlet slider valve, an annular inlet slider valve, a rotary inlet valve, and combinations thereof.

8. The engine of claim 7, wherein the rotary inlet valve comprises triangular intake slots.

9. An entry ignition engine with a two-stage compression and two-stage expansion, comprising:
an inlet valve at one end of a first compression chamber, wherein the first compression chamber comprises a first compression piston at an end opposite the one end of the inlet valve;
a conduit connecting an open portion of the first compression chamber to an open portion of a second compression chamber, wherein the conduit comprises a conduit valve;
the second compression chamber comprising a second compression piston at one end opposite the open portion;
a pressure reservoir coupled to the second compression chamber on one end and a combustion chamber on another end, wherein the pressure reservoir comprises a fuel injector,
a valve between the pressure reservoir and the combustion chamber, wherein the valve is configured to open and close one or more channels between the pressure reservoir and the combustion chamber;
wherein the combustion chamber comprises a combustion chamber piston and wherein the combustion chamber is coupled to an exhaust chamber;
an exhaust valve between the combustion chamber and the exhaust chamber;
wherein the exhaust chamber comprises an exhaust chamber piston; and
a second exhaust valve at an end opposite the exhaust chamber piston.

10. The engine of claim 9, wherein the conduit connecting the pressure reservoir to the mixing chamber comprises a baffle.

11. The engine of claim 9, further comprising a thermal insulation layer for at least one of: the pressure reservoir, the conduit connecting the pressure reservoir to the mixing chamber, the mixing chamber, and combinations thereof.

12. The engine of claim 9, wherein the mixing chamber further comprises means for a cold start ignition.

13. A method of operating an entry ignition engine, the engine comprising a compressor coupled to a pressure reservoir, wherein the pressure reservoir comprises a conduit connected to a mixing chamber, wherein the mixing chamber comprises a fuel injector, and wherein the mixing chamber is coupled to a combustion chamber, a valve at the opening of the combustion chamber, wherein the valve is configured to open and close one or more channels between the mixing chamber and the combustion chamber, an exhaust valve at the opening of the combustion chamber;
and a valve actuator connected to the exhaust valve, the method comprising:
the compressor receiving air, wherein the air flows into the pressure reservoir; the fuel injector providing a fuel into the mixing chamber, wherein the fuel mixes with the air flow from the pressure reservoir,
the combustion chamber receiving the fuel-air mixture from the mixing chamber, wherein the valve is configured to open when pressure in the mixing chamber is greater than pressure in the combustion chamber and wherein the valve is configured to close when the pressure in the combustion chamber is greater than the pressure in the mixing chamber,
transferring out the combusted fuel-air mixture through the exhaust valve; and
the valve opening upon the transfer of the combusted fuel-air mixture through the exhaust valve.

14. The method of claim 13, wherein the conduit connecting the pressure reservoir to the mixing chamber comprises a baffle.

15. The method of claim 13, further comprising a thermal insulation layer for at least one of: the pressure reservoir, the conduit connecting the pressure reservoir to the mixing chamber, the mixing chamber, and combinations thereof.

16. The method of claim 13, wherein the compressor comprises an isothermal compressor and wherein a heat exchanger couples the output of the isothermal compressor to the input of the pressure reservoir.

17. The method of claim 13, further comprising two or more compressors, wherein one or more intercoolers connects the two or more compressors to each other.

18. The method of claim 13, wherein the mixing chamber further comprises means for a cold start ignition.

19. The method of claim 13, further comprising at least one of: a linear inlet slider valve, an annular inlet slider valve, a rotary inlet valve, and combinations thereof.

20. The method of claim 19, wherein the rotary inlet valve comprises triangular intake slots.
